(19) United States
(12) Patent Application Publication
(10) Pub. No.: US 2006/0072778 A1
(43) Pub. Date: Apr. 6, 2006

(54) Encoding invisible electronic information in a printed document

(75) Inventor: Steven J. Harrington, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation.

(21) Appl. No.: 10/951,394

(22) Filed: Sep. 28, 2004

(51) Int. Cl. G06K 9/00; G06K 9/36

(52) U.S. Cl. 382/100; 382/232

(57) ABSTRACT

Substantially invisible elements of an electronic code can be embedded in a document independent of the layout of the image being displayed to provide document related data. Generally, code elements are printed in a color that has luminance values that do not vary substantially from the luminance of the location on the document where they are placed. Thus, the embedded data will be substantially invisible to the human eye at normal reading distances, yet capable of being captured by a conventional digital scanner. In one aspect, elements of the code are printed on a black and white document, as blue dots in content locations and as yellow dots in background locations. To decode the information, the system and method identifies locations for potential code element candidates based upon the relative luminance of the pixel and the surrounding location of the image. The pattern in which all elements of the code are positioned in the image is then identified and output values are assigned to all characters that belong to the code depending upon the relative dominance of blue light reflected from the respective location in the image. Significantly, the present system and method enables information that is related to the document image to be printed and detected at all pixels in a document.

This relates generally to systems and methods for processing scanned image data and more particularly, to printing hardcopy images with invisible electronic codes that can be digitally captured and reproduced to provide information related to the document.

### BACKGROUND

It is often useful to access information related to a hardcopy document. For example, programs that verify user permissions and passwords are often used to control access to sensitive information and version numbers, modification dates and other document properties are provided so users can confirm that they are viewing the correct data. Document storage locations and similar information may be identified to enable those who receive the document to edit and/or distribute its contents.

While it is relatively easy to deliver such information with electronically stored documents, the information is usually lost when a document is printed. Thus, even if a printed version of the document is scanned and returned to electronic storage, the related information is no longer associated with the document. As it is often vital to provide documents with related information, it is advantageous to provide a method and system for maintaining such associations as documents are digitally captured, processed and printed.

Known devices and systems provide document storage location identifiers, hyperlinks, software code and other data that can be printed on the surface of hardcopy documents fairly easily for use in accessing related information. While these forms of data can be useful, it is often preferable to deliver data directly to the program or device that can actually produce the related information and preferably, to deliver the data in a processing format that is useful to the program or device. Barcodes and glyphs can typically be used to identify information related to image content, printed on hardcopy media and captured by a conventional scanner. Unfortunately they are also highly visible, which often causes them to detract from the visual appearance of the document. Magnetic inks, gloss marks and other substances that are much less visible are also available, but the costs of providing the equipment that is required to capture the data often renders the use of those substances impractical.

It is desirable to provide printed documents with data that can be used to access information related to the content of a printed document that will not alter its visual appearance, and still be captured and reproduced by conventional scanners and printers.

### PRIOR ART

U.S. Pat. No 6,631,495 discloses an electronic document filing method and system that comprises identification code addition means for adding identification code proper to the electronic document thereto, electronic document transfer means for registering the electronic document to which the identification code is added to the document server, print means for printing the registered electronic document and the identification code on the same paper face, identification code read means for reading the identification code printed on the paper face, identification code interpretation means for interpreting the identification code read by the identification code read means, and identification code transfer means for transferring the identification code interpreted by the identification code interpretation means to the document server.

U.S. Pat No. 6,644,764 discloses a document printing and verification system and method that includes a printing apparatus for printing an image on a print medium, an inkjet printer apparatus for printing an invisible identification pattern such as a barcode on the print medium which is invisible to the naked eye under normal ambient illumination and a scanner apparatus positioned for producing an image of the identification image for verification use. The inkjet ink includes a UV dye and an FR/IR dye. The UV dye when illuminated with UV light provides an image of the barcode which is visible to the naked eye. The FR/IR dye is imaged using an FR/IR camera to capture electronically an image of the barcode.

U.S. Pat. No. 6,515,764 discloses a method and apparatus for detecting photocopier tracking signatures placed on documents produced by color photocopiers. The apparatus includes an image processing unit that generates an output image based on differences between corresponding pixel values of at least two of the plurality of color separations. The apparatus further includes an output terminal for displaying the output image to view the photocopier tracking signature. Color differences can be detected by combining two or more of the color separations into a resulting monochromatic image and then enhancing the resulting color differences. The combination of the separations exposes small color differences that are not detectable in any of the individual separations, thus enabling the photocopier signature to be detected.

U.S. Pat. No. 6,212,234 discloses converting a color image of a dot-sequential system into a color image of a field-sequential system and encoding/decoding the color image at a high speed with a high compression ratio. A pixel value of image data of a dot-sequential system is sequentially inputted to a reference area generating means, and the reference area generating means outputs target pixel data and reference area data. A same pixel value distributing and generating means generates and outputs a same pixel value distribution from the target pixel data and the reference area data. A predictive information encoding means encode data in accordance with an encoding generating table, and outputs predictive information encoded data and an encoding result signal.

### SUMMARY

Aspects disclosed herein provide a data encoder that includes an input channel configured to receive pixels for an input image; a code element pattern producer configured to produce an input image independent positioning pattern for elements of an electronic code; a code element candidate identifier that identifies pixels in locations corresponding to the positioning pattern and determines a density output value for the identified pixels in a selected input image separation; and a code element color generator configured to provide a color value for the identified pixels based upon a density output value for the identified pixel in the selected separation.

In one aspect, a method includes receiving input pixels representing an input image that includes substantially invisible elements of an electronic code; producing an input image independent positioning pattern for the substantially invisible code elements; identifying a plurality of pixels in the input image that are in locations corresponding to the input image independent pattern; determining a colorant print amount for the identified pixel in a selected separation; and printing a substantially invisible code element at the identified pixel, with the substantially invisible code element color determined by the colorant print amount for the selected separation.

In another aspect, a digital printing system includes an image processor configured to generate binary printer signals that represent an input image, the input image having a plurality of substantially invisible elements of an electronic code positioned therein independent of an input image content layout; a print channel configured to receive the binary printer signals from the image processor as a plurality of separations; and an output generator configured to generate a hardcopy reproduction of the substantially invisible code element containing input image.

In yet another aspect, a data decoder includes an image sensor configured to capture an input image that includes a plurality of substantially invisible elements of an electronic code as pixels that represent an intensity of light reflected the input image; a code element locator configured to identify a plurality of pixels that have a color value that is substantially different from the average color value for a surrounding neighborhood and a luminance value that is substantially the same as an average luminance value for a surrounding neighborhood; a code element pattern detector configured to detect a layout pattern for the electronic code based upon a spatial relationship of the code element locator identified pixels; and an electronic code generator configured to identify input image pixels corresponding to the electronic code pattern and assign output values to the identified electronic code pattern corresponding pixels based upon a dominance of a selected color of light reflected from the input image.

In still another aspect, a method includes capturing an input image that includes a plurality of substantially invisible elements of an electronic code, at least one of which is positioned in a content of the input image; and processing a plurality of the substantially invisible code elements to provide information related to the input image.

### BRIEF DESCRIPTION OF THE DRAWINGS

FIG. 1 is a simplified diagram showing the basic elements of a color digital printer.

FIG. 2 is a simplified diagram showing the basic elements of a raster input scanner.

FIG. 3 provides one example of a positioning pattern for elements of an electronic code.

FIG. 4 shows an example of a hardcopy document that includes substantially invisible code elements.

FIG. 5 is a flow chart showing aspects of the present system and method for decoding electronic information that is captured from a hardcopy document.

FIG. 6 is a flow chart showing an example of how code elements can be identified using one or more aspects of the present system and method.

FIG. 7 is an example of a code pattern that may be obtained using the present system and method.

FIG. 8 is a flow chart that provides an example of how digital values may be assigned to code elements using the present invention.

### DETAILED DESCRIPTION

For a general understanding of the present invention, reference is made to the drawings, where like reference numerals have been used throughout to designate identical elements. In describing the present invention, “a” means “one or more” and a “plurality” means “more than one.” The following term(s) have also been used in the description:

“Data” refers to electronic signals that indicate or include information. Data may exist in any physical form, including electromagnetic or other transmitted signals, signals that are stored in electronic, magnetic, or other form or signals that are transitory or are in the process of being stored or transmitted.

“Viewable data” refers to data that typically can be perceived by the human visual system. In contrast, “substantially invisible data” is data that present but is barely detectable (or undetectable) by the human eye at distances at which the average person would ordinarily view the data.

An “image” is generally a pattern of physical light that may include characters, words, and text as well as other features such as graphics. An image is typically represented by a plurality of pixels that are arranged in scanlines. An input image is an image that is or has been presented for digital capture.

An “input image” is an image that has been generated by an external source that is presented to the reference system for processing.

A “document” includes any medium that is capable of bearing a visible image. An “original document” is a document that bears an input image.

A “separation” is to a bitmap of image signals that is used to drive a printer produce a monochromatic image.

A “pixel” is a digital signal that represents the optical density of the image in a single separation at a discrete location.

A “color pixel” refers to the sum of color densities of corresponding pixels in each separation.

“Grayscale” means having multiple intensity levels that correspond to respective optical density values. For a given device, the number of available grayscale levels is determined by its bit depth.

“Grayscale value” refers to the numerical value that represents a single intensity level in a range that varies between a minimum intensity level and a maximum intensity level. A grayscale value is assigned to each pixel in a digital image to indicate the optical density of the image at the corresponding location.

“Color” is the appearance of an object as perceived by a viewer depending upon the hue, brightness and saturation of light reflected from the object.

A “color image” is an image formed by superimposing multiple monochromatic separations, each of which reproduces a color of the image.

A “neighborhood” is a group of pixels that lie adjacent to or surround a reference pixel in an image. It is typically described by its size and shape.

“Resolution” is a number that describes pixels in an output device. For a video display, resolution is typically expressed as the number of pixels on the horizontal axis and the number of pixels on the vertical axis. Printer resolution is often expressed in terms of “dots-per-inch” i.e., the number of drops of marking material that can be printed within an inch on the page, which is often, but not necessarily, the same in both directions.

The term “electronic code” refers to a set of digital values that represents information. An “electronic code element” is an individual character in an electronic code.

A “code element positioning pattern” is the spatial positioning arrangement for a full set of elements that form an electronic code.

There are many ways to digitally reproduce images. For example, digital cameras, scanners and other image capture devices generate digital reproductions of analog data. In addition, there are numerous software applications that enable users to create text and graphic images in digital format. Digital image data can also be received via electronic transmission and retrieved from storage. Regardless of how it is created, digital information can be printed, transmitted and displayed by printers, video monitors, fax machines and other output devices.

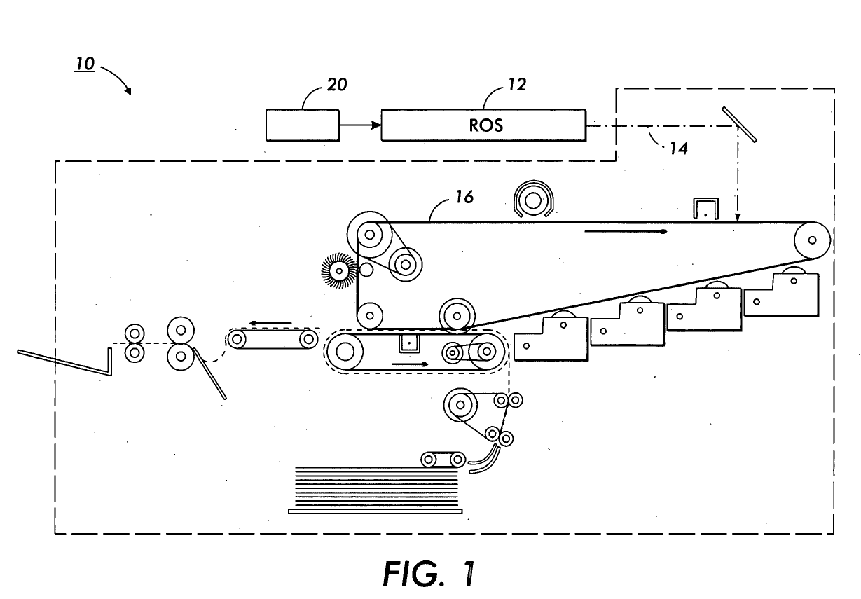

In a typical color system, color documents are represented by multiple separations of grayscale image data, each of which provides the pixels that drive a printer to produce one layer of color in an image. Color images are formed by combining the optical density values for corresponding pixels in respective separations. As illustrated in FIG. 1, a digital printer 10 reproduces color images by processing binary “CMY” image data to generate multiple image separations that are used to print cyan (C), magenta (M) and yellow (Y) colors (and optionally and black (K) color in lieu of or in addition to cyan, magenta and yellow) on a hardcopy sheet. In one aspect, a digital printer 10 may include a raster output scanner (ROS) 12 that drives a modulated a light 14 in response to electronic signals that are independently processed by an image processor (IP) 20 for the respective separations. Modulated light 14 exposes the surface of a uniformly charged photoconductive belt 16 to achieve a set of subtractive latent images. The latent images are subsequently developed by depositing (K), C, M and Y colorants onto the charge retaining locations. The developed images are then transferred to a hardcopy sheet in superimposed registration with one another and fused to the sheet to form a color copy.

Each of the aforementioned colorants absorbs light in a limited spectral region of the range of visible light; cyan colorant absorbs red light, i.e., prevents light having a wavelength of approximately 650 nm from being reflected from the image, magenta colorant absorbs green light (light having a wavelength of approximately 510 nm) and yellow colorant absorbs blue light (light having a wavelength of approximately 475 nm). Black colorant absorbs all wavelengths of light and can be deposited onto the latent image rather than depositing all three colorants at the same location. Accordingly, all of the printable colors can be produced by combining the different colorants in various ratios. For example, to generate a blue region in a hardcopy image, relatively high amounts of colorant will be deposited onto corresponding locations of the C and M separations, with little or no colorant deposited in the corresponding location of the Y separation. The cyan and magenta colorants will absorb the red and green light and thus, only blue light will be reflected from the hardcopy sheet and perceived by the viewer.

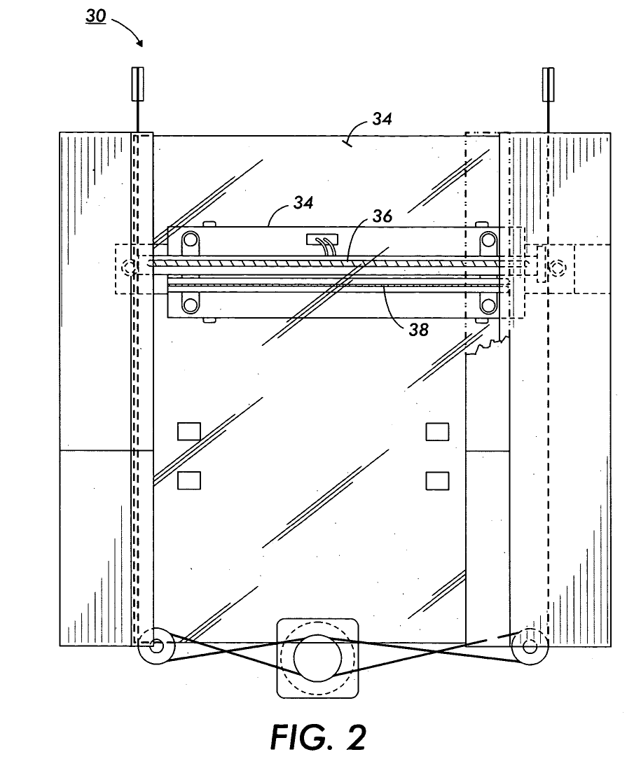

Scanners, digital cameras and other devices that are capable of generating digital image data reproduce color quite differently. An example of a raster input scanner (RIS) 30, one well known image capture device, is illustrated in FIG. 2. As shown RIS 30 may be mounted to a moving carriage assembly 34 and placed below a glass platen 32. A lamp 36 illuminates an original document that is positioned on platen 32 and an image sensor 38, which is typically mounted to carriage 34, is placed in relative motion with platen 32. Image sensor 38 includes a plurality of sensor elements that capture the image by detecting the intensity of light reflected from a corresponding locations in the image and storing it as a proportionate electrical charge. In the case of a color image, the sensor elements separately detect red (R), green (G) and blue (B) components of visible light that are reflected from the image. The analog charges for each color component are separately forwarded to IP 20, where they are quantized to generate grayscale pixel values in three overlapping R, G and B image data planes.

Since digital input and output devices generate and process data differently, the printing of scanned images usually requires some form of image processing. IP 20 (shown in FIG. 1) typically receives and processes the grayscale RGB image data generated by RIS 30 and performs several processes, one of which includes the conversion of grayscale RGB data to binary CMYK data for output by printer 10. Quite often, the conversion between RGB and CMYK data involves an intermediate conversion to device independent luminance-chrominance data. For example, it is common to convert RGB data to LCrCb data, which describes each color in terms of its luminance (L), red-green chrominance (Cr) and blue-yellow chrominance (Cb).

LCrCb color data provides a color description that simulates the way color is processed by the human eye. More specifically, the human vision system perceives color using a luminance channel and two opponent chrominance channels, one for detecting red-green chrominance differences and one for detecting blue-yellow chrominance differences. The human eye is much more sensitive to overall changes in luminance than chrominance and therefore, most of the information about a scene is contained in the luminance component. In a digital printing system, IP 20 converts the data for the luminance and chrominance channels to binary CMYK printer signals and like the human eye, transmits the data over separate channels that process the luminance, red-green chrominance and blue-yellow chrominance data more or less independently. Accordingly, IP 20 provides a color description that causes the output image to be perceived by the human eye as having colors that closely match those of the input image.

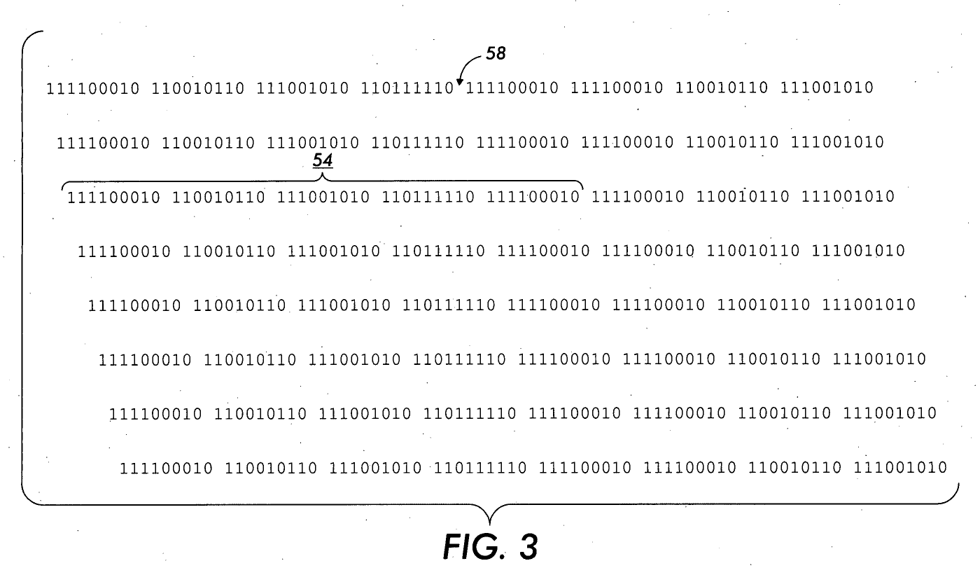

Turning to FIG. 3, the present system and method provides an electronic code 54 that can be used to access information related to a hardcopy document 40. In one aspect, at least some of the characters that form electronic code 54 can be placed in a document 40 in a predetermined positioning pattern 58 that is independent of the layout in which the image is printed on the page. Advantageously, electronic codes 54 can be placed anywhere on a document 40, regardless of whether the location is a content region or a background region. In one aspect, positioning pattern 58 can be designed with the goal of placing the characters on document 40 in a way that is easy to detect and decode them. For example, electronic code 54 may be provided in sequential scanlines, in scanlines that are generated at periodic intervals and/or in pixel positions that are vertically aligned. In such cases, the entire electronic code 54 could be located by analyzing only those pixels that are vertically aligned with the characters that have already been identified. However, it is understood that neither vertical nor horizontal alignment is required and that positioning pattern 58 may be provided in other arrangements.

In the example of FIG. 3, an electronic code 54 for a string of text is provided using the 7-bit ASCII code for each character, a parity bit and a separator bit. In this example, the parity and separator bits have been added to the ASCII code to aid in checking decoding errors and to enable to detected bits to be properly aligned in the ASCII byte codes. As shown, positioning pattern 58 causes electronic code 54 to be repeatedly printed across document 40 and in sequential lines, with each line offset from the previous line by one character. It is understood, however, that positioning pattern 58 could be provided in numerous other arrangements and that electronic code 54 could include digital data other than ASCII codes

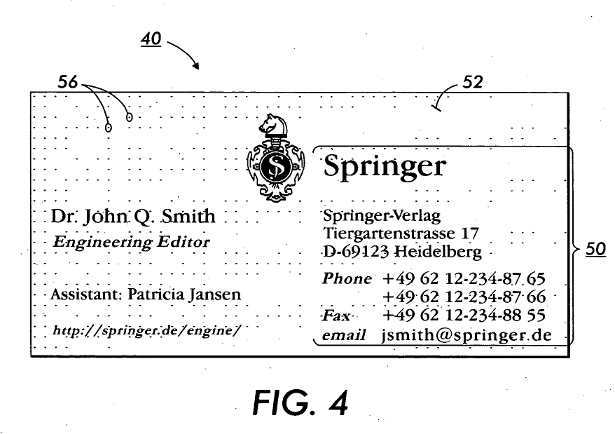

Turning to FIG. 4, positioning pattern 58 defines the locations in image 50 where i the characters that form an electronic code 54 can be printed. However, whether a code element 56 will be printed at the location depends upon its luminance characteristics. For example, a code element candidate signal can be generated each time a pixel corresponds to positioning pattern 58, in which case a code elements 56 will be printed at the pixel if where the luminance characteristics are substantially the same as that of the colorant that will be used to print code element 56. More specifically, whether a pattern signal will cause an electronic code element 56 to be printed depends upon the state of the print channel that controls the deposit of colorant in a selected separation of the image. In one aspect, code elements 56 are printed at a pixels identified by positioning pattern 58 when the defined pixel has either a maximum or minimum pixel value for a selected separation. When both of these conditions are met, if the pixel has the minimum pixel value, code element 56 will be printed a color with a luminance value that closely matches that of the hardcopy sheet and if the pixel has the maximum pixel value, code element 56 will be printed in a color that will be perceived by the human eye as being opposite that of the hardcopy sheet.

FIG. 4 shows one example of how the present system and method can be used to encode electronic information in such an image. Office documents typically have black text printed on a white hardcopy sheet. If documents such as these are printed using a color printer, black text will be found where the pixel values for all channels have maximum output and the sheet will be blank where all of the print channels are turned off. In one aspect, printer 10 may rely upon the state of the channel that controls printing of the yellow separation of the image (the “Y channel”) to print code elements 56. Thus, when a pixel corresponds to positioning pattern 58, code elements 56 can be printed in yellow where the pixel value is the minimum available value and in blue where the pixel is the maximum available value. Thus, code elements 56 can be printed in both content and background locations of image 50 that correspond to pattern 58 as long as the selected print channel has the appropriate output.

In one aspect, code elements 56 will be printed as blue dots at in content locations and as yellow dots in background locations. Since the variation in luminance between yellow code elements 56 and the blank background locations is small as is the variation in luminance between blue code elements 56 and the black text regions, all of the code elements 56 will be substantially invisible to the human eye at normal reading distances. However, code elements 56 will still reflect light in the visible spectral range and thus, they will be captured by a typical digital scanner and their output values can be detected. While the color of code elements 56 will differ from that of the location where they are printed, the relatively low sensitivity of human eye to chrominance differences (as compared to luminance changes) will cause the color differences to remain virtually undetectable.

Still referring to FIG. 4, if a color image 50 is displayed on document 40, code elements 56 can be printed in any location where the Y channel has maximum or minimum output, regardless of the state of the C channels and the M channel. Thus, yellow dots may be printed in blank regions and also in content locations where cyan and/or magenta colorant is printed in the absence of yellow colorant. Similarly, blue dots can be printed in any location where the maximum amount of yellow colorant will be deposited (prior to any undercolor removal and gray component replacement), either alone or with any amount of cyan and/or magenta colorant.

It is noted that while the present system and method is described as having code elements 56 that are formed by the absence and/or presence of blue and yellow dots at designated locations, code elements 56 may be printed in other colors. Generally, code elements 56 will be substantially invisible so long as their luminance varies only slightly from the locations where they are printed. For example, in a document 40 with a green content location printed on a red hardcopy sheet, it may be advantageous to print magenta code elements 56 where the M channel is off and to print cyan code elements 56 where the M channel provides maximum output.

It is also noted that, while aspects of the present system and method are described by referring to code elements 56 as “dots,” it is not intended to code elements 56 are not limited to having a particular shape and/or size. Code elements 56 may have any shape and they need only be large enough to enable printer 10 and scanner 30 to reliably produce and detect them. For example, code elements 56 should have sufficient size to enable them to be distinguished from halftone dots and to print and capture well. In one aspect, code elements 56 may be on the order of the size of the halftone cell or on the order of the size of 2-4 pixels, depending upon the resolution of the scanner and printer. Code elements 56 should also remain small enough to avoid being visible at distances from which the average person would ordinarily view an image.

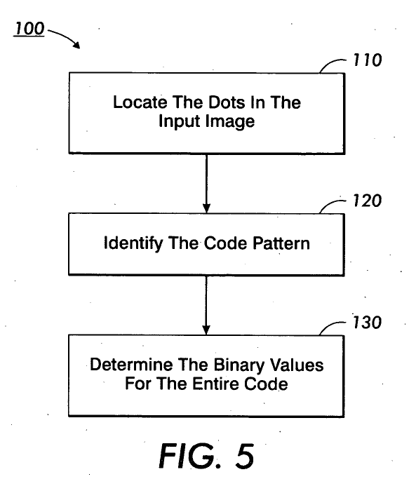

Turning to FIG. 5, a conventional RIS 30 can be configured to capture code elements 56 that have been printed in any location on an original document 40 in the manner described above. Code elements 56 can therefore, be captured and their spatial positioning can be used to obtain the entire pattern 58. Output values for all of the characters of electronic code 54 can then be determined from the color of the light reflected from the image at each location. Generally, electronic code 54 is obtained by locating code elements 56 that have been printed on original document 40 as shown in block 110 and using the located code elements 56 to identify positioning pattern 58 as shown in block 120. Once positioning pattern 58 is identified, the output values that correspond to the entire code 54 can be obtained as shown in block 130.

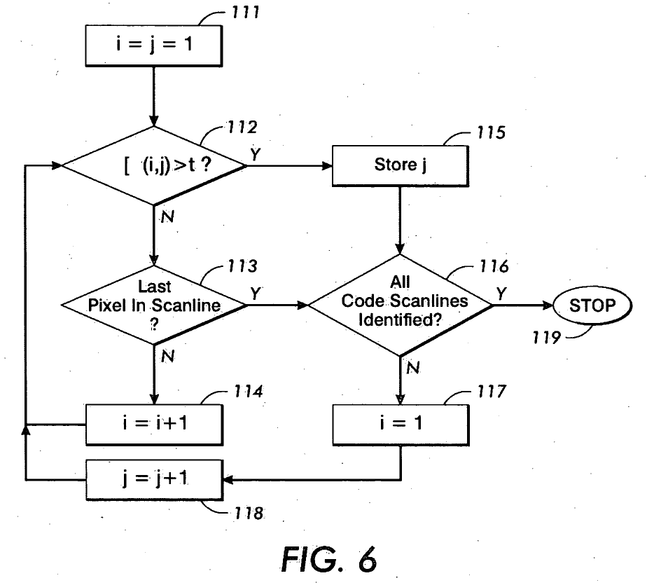

Referring to FIG. 6, the present system and method are hereinafter described with reference to a document 40 with black image content printed on a white hardcopy sheet, with blue code elements 56 printed in content regions and yellow code elements. 546 printed in background locations. As explained above, however, code elements 56 could be printed in other colors and/or on non-white hardcopy sheets. Candidate pixels for code elements 56 are those pixels where the color value has a yellow-blue intensity (YB) that exceeds a predetermined threshold (t). That is:
YB=|B−(R+G)/2|−|R−G|>t

Thus, a given pixel is identified as belonging to a code element 56 when its color value is dominated by signals that correspond to the blue-yellow chrominance channel (Cb). Arguably, the YB luminance for a given pixel could simply be measured by the absolute difference between the B luminance and the average of the intensities of the R and G luminances. However, subtracting the absolute difference of the R and G luminances has shown to reduce false positives in high noise areas of the image.

As shown in blocks 111-114, the above-described blue-yellow chrominance comparison is performed beginning with the first pixel in the first scanline and then to each pixel in successive scanline until the first code element 56 is located. Subsequent scanlines are then checked for code elements 56. Each time a code element 56 is located in a given scanline, the scanline location is stored in a least squares calculation as indicated in block 115 and a least-squares fit is performed for the fast-scan direction as indicated in block 116. Processing is completed when the first scanline that does not include a code element 56 is detected.

As a result of the above described process, all scanlines that include code elements 56 will have been located and document 40 can then be processed to locate the column locations for code elements 56. In one aspect, document 40 is rotated by 90 degrees and processed again to identify code elements 56 that are aligned in the slow-scan direction. It is understood that since code elements 56 were printed on the original document 40 only in locations that meet limited criteria, some of the other points found at scanline and column intersections may also provide values for belong to code 54. The arrangement of positioning pattern 58 is first refined and additional values are obtained for code 54.

In one aspect, the identification of positioning pattern 58 includes determining the spacing between scanlines and columns and determining matching lines 62 to connect code elements 56 in each direction. The spacing between code elements 56 may be obtained, for example, by obtaining a rough average of the distance between code elements 56 in consecutive scanlines (or columns) and then comparing the spacing between each scanline (or column) to the rough average to estimate the number of scanlines (or columns) that are located between the scanlines (or columns) being considered. Once scanline and column spacings are determined, the fully arranged positioning pattern 58 is available and the locations of the remaining values for code 54 can be identified, for example, using a least-squares fit of the points where the matching lines in code positioning pattern 58 intersect.

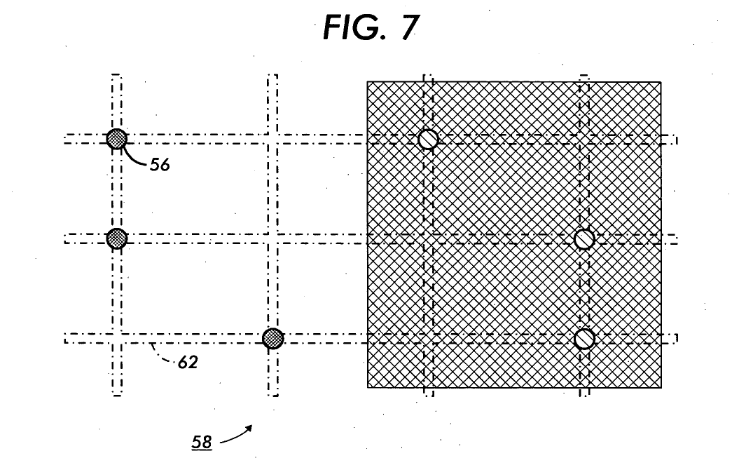

FIG. 7 provides an example of a code positioning pattern 58 that has been identified as described. As shown, the intersection points for matching lines in the fast scan and slow scan directions are printed in both background and text regions of image 50. The present system and method may optionally determine the average slope of the scanlines and columns to determine whether there is any skew in the image. Binary values are assigned to code elements 56 based upon the intensity of blue light that is captured from the corresponding pixel during scanning. In one aspect, the value of code element 56 is set to 1 if the absolute B value (i.e., blue-yellow chrominance) is relatively high and it is set to 0 if the absolute B value is relatively low. In one aspect, a de-screening method such as low-pass filter or sigma filter may be done to prior to trying to read the hidden data for the purpose of removing the high-frequency colorant variations of the halftone screen, while leaving a lower frequency signal for the encoded hidden data.

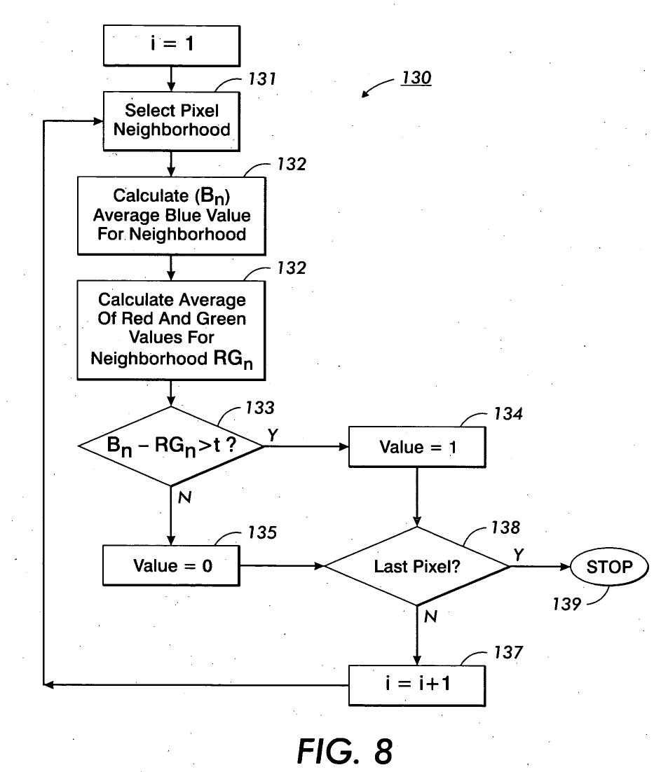

FIG. 8 is a detailed view showing how digital values that have been assigned to code 54 may be determined. As shown, a neighborhood that surrounds each location where a value for code 54 is expected is selected at block 131. Generally, neighborhood 64 should be large enough to encompass the encoded value in spite of any error that may have taken place during printing, scanning and fitting code positioning pattern 58, but small enough to maintain good signal strength. For example, a neighborhood may be on the order of a few pixels surrounding the encoded value on one or more sides. A neighborhood may have any shape, including square, rectangular or any other shape that is appropriate for assessing average light intensities under the particular circumstances. The average blue “B” value for the neighborhood surrounding each newly identified pixel is then calculated at block 132 and the average difference (“RG”) between the red “R” and green “G” values for the neighborhood is calculated at block 133. The absolute difference between B and RG for the neighborhood is compared to a threshold at block 134. If it exceeds the threshold, the yellow-blue chrominance is relatively high compared to the red-green chrominance and a value of 1 is assigned to code element 56. If the absolute difference does not exceed the threshold, yellow-blue chrominance is relatively low compared to red-green chrominance a 0 is assigned.

Although the invention has been described with reference to specific embodiments, it is not intended to be limited thereto. Rather, those having ordinary skill in the art will recognize that variations and modifications, including equivalents, substantial equivalents, similar equivalents, and the like may be made therein which are within the spirit of the invention and within the scope of the claims.

What is claimed is:

1. A data encoder, comprising:
an input channel configured to receive pixels for an input image;
a code element pattern producer configured to produce an input image independent positioning pattern for elements of an electronic code;
a code element candidate identifier that identifies pixels in locations corresponding to said positioning pattern and determines a density output value for said identified pixels in a selected input image separation;
and a code element color generator configured to provide a color value for said identified pixels based upon a density output value for said identified pixel in said selected separation.

2. A data encoder as claimed in claim 1 further comprising a code element color generator further configured to assign a content location color value to an identified pixel if said identified pixel density output value is a maximum density output value for said selected input image separation.

3. A data encoder as claimed in claim 2 further comprising a code element color generator configured to assign a background location color value to an identified if said density output value is a minimum density output value for said selected input image separation.

4. A data encoder as claimed in claim 3 wherein said code element color generator is further configured to assign to said identified pixel, a color value with a luminance that is substantially the same as a luminance of an original color value for said identified pixel.

5. A data encoder as claimed in claim 3 wherein said selected image separation represents an intensity of blue light reflected in an RGB description of a color input image.

6. A data encoder as claimed in claim 3 wherein said selected separation controls a deposit of a yellow colorant onto a color image formed by combining cyan, magenta and yellow colorants.

7. A data encoder as claimed in claim 5 wherein said content location color value represents blue and said background location color value represents yellow.

8. A data encoder as claimed in claim 3 wherein said pattern has code elements that are vertically aligned.

9. A data encoder as claimed in claim 3 wherein said pattern has code elements that are horizontally aligned.

10. A method, comprising:
receiving input pixels representing an input image that includes substantially invisible elements of an electronic code;
producing an input image independent positioning pattern for said substantially invisible code elements;
identifying a plurality of pixels in said input image that are in locations corresponding to said input image independent pattern; determining a colorant print amount for said identified pixel in a selected separation;
and printing a substantially invisible code element at said identified pixel, with said substantially invisible code element color determined by said colorant print amount for said selected separation.

11. A method as claimed in claim 10 further comprising printing a content color substantially invisible code element at said identified pixel if said colorant print amount is a maximum colorant print amount for said selected separation.

12. A method as claimed in claim 11 further comprising printing a background color substantially invisible code element at said identified pixel if said colorant print amount is a minimum colorant print amount for said selected separation.

13. A method as claimed in claim 10 wherein a substantially invisible code element luminance is substantially the same as an original luminance of said identified pixel.

14. A method as claimed in claim 10 wherein said background color substantially invisible electronic code element is yellow and said content color substantially invisible electronic code element is blue.

15. A method as claimed in claim 10 wherein said substantially invisible code element positioning pattern provides vertically aligned substantially invisible code elements.

16. A method as claimed in claim 10 wherein said substantially invisible code element positioning pattern provides horizontally aligned substantially invisible code elements.

17. A digital printing system, comprising:
an image processor configured to generate binary printer signals that represent an input image, said input image having a plurality of substantially invisible elements of an electronic code positioned therein independent of an input image content layout;
a print channel configured to receive said binary printer signals from said image processor as a plurality of separations;
and an output generator configured to generate a hardcopy reproduction of said substantially invisible code element containing input image.

18. A digital printing system as claimed in claim 17 further comprising:
a code element pattern producer configured to produce a positioning pattern for said substantially invisible code elements;
a code element candidate identifier that identifies a pixel corresponding to said positioning pattern and provides a colorant amount for said identified pixel in a selected separation; and
a content location code element generator configured to deposit a content location substantially invisible code element at said identified pixel if said indicated colorant amount is a maximum colorant amount for said selected separation.

19. A digital printing system as claimed in claim 18 further comprising a background location code element generator configured to deposit a background location substantially invisible code element at said identified pixel if said indicated colorant amount is a minimum colorant amount for said selected separation.

20. A digital printing system as claimed in claim 17 wherein said selected separation represents an intensity of blue light reflected in an RGB description of a color input image.

21. A data decoder, comprising:
an image sensor configured to capture an input image that includes a plurality of substantially invisible elements of an electronic code as pixels that represent an intensity of light reflected said input image;
a code element locator configured to identify a plurality of pixels that have a color value that is substantially different from said average color value for a surrounding neighborhood and a luminance value that is substantially the same as an average luminance value for a surrounding neighborhood;
a code element pattern detector configured to detect a layout pattern for said electronic code based upon a spatial relationship of said code element locator identified pixels; and
an electronic code generator configured to identify input image pixels corresponding to said electronic code pattern and assign output values to said identified electronic code pattern corresponding pixels based upon a dominance of a selected color of light reflected from said input image.

22. A data encoder as claimed in claim 21 wherein said substantially invisible code elements are positioned in said input image independent of a layout of an input image content.

23. A data decoder as claimed in claim 21 wherein said electronic code generator is configured to said assign output values to said electronic code pattern corresponding pixels depending upon a dominance of blue light reflected from said input image.

24. A data decoder as claimed in claim 21 wherein said input images is captured by a conventional digital scanner.

25. A data decoder as claimed in claim 21 wherein said input images is captured by a digital scanner that detects red, green and blue components of visible light, has an 8 bit depth and is capable of generating 256 levels of color for each of said red, green and blue light components.

26. A data decoder as claimed in claim 21 wherein said electronic code value generator is further configured to assign an output value of 1 to each pixel where:

|B−(R+G)/2|−|R−G|>T,
wherein T is a threshold value, B is a value that represents the intensity of blue light reflected from said input image, R is a value that represents an average intensity of red light reflected from a surrounding neighborhood and G is a value that represents an average intensity of green light reflected from a surrounding neighborhood.

27. A data decoder as claimed in claim 26 wherein said selected light component represents an intensity of blue light reflected in an RGB description of a color input image.

28. A data decoder as claimed in claim 26 wherein said electronic code generator is further configured to assign output values to a portion of said electronic code based upon an intensity of yellow light reflected from said image at pixels that correspond to said electronic code pattern.

29. A method, comprising:
capturing an input image that includes a plurality of substantially invisible elements of an electronic code, at least one of which is positioned in a content of said input image;
and processing a plurality of said substantially invisible code elements to provide information related to said input image.

30. A method as claimed in claim 29 further comprising:
identifying electronic code element candidate pixels with color values that are substantially different from the average color of a surrounding neighborhood and luminance values that are substantially the same as an average luminance of a surrounding neighborhood;
detecting a layout pattern for said electronic code based upon a spatial arrangement of said identified code element candidate pixels;
identifying input image pixels corresponding to said electronic code pattern; and
assigning output values to said identified electronic code pattern corresponding pixels based upon a dominance of light reflected from said input image having primarily a selected color.

31. A method as claimed in claim 30 wherein said primarily reflected light color is blue.

32. A method as claimed in claim 30 wherein said primarily reflected light color is yellow.

33. A method as claimed in claim 30 further comprising processing said electronic code to provide device readable output.

34. A method as claimed in claim 30 further comprising processing said electronic code to provide information related to said input image.

35. A method as claimed in claim 30 further comprising processing said electronic code to provide viewable data.
